(19) United States
(12) Patent Application Publication
(10) Pub. No.: US 2021/0319464 A1
(43) Pub. Date: Oct. 14, 2021

(54) EVALUATION SUPPORT APPARATUS, EVALUATION SUPPORT METHOD AND PROGRAM

(71) Applicant: NIPPON TELEGRAPH AND TELEPHONE CORPORATION, Tokyo (JP)

(72) Inventors: Machiko SHINOZUKA, Musashino-shi, Tokyo (JP); Takeshi ORIGUCHI, Musashino-shi, Tokyo (JP); Hidetoshi TAKADA, Musashino-shi, Tokyo (JP); Takashi FURUTANI, Musashino-shi, Tokyo (JP)

(21) Appl. No.: 17/268,210

(22) PCT Filed: Jul. 18, 2019
(86) PCT No.: PCT/JP2019/028330

§ 371 Date: Feb. 12, 2021

(30) Foreign Application Priority Data
Aug. 21, 2018 (JP) 2018-154890

(51) Int. Cl. G06Q 30/02; G06F 40/30

(52) U.S. Cl. CPC G06Q 30/0203; G06F 40/30

(57) ABSTRACT

An assessment support device capable of efficiently acquiring the elements of the value of an ICT service is provided. The assessment support device includes: a question generation unit that generates a plurality of questions including a plurality of stages of values with respect to advantages felt about an assessment target service as choices on the basis of information related to states of a user when the user uses the service and when the user does not use the service; an answer acquisition unit that acquires answers of a plurality of persons with respect to the plurality of questions generated by the question generation unit; and a statistics calculation unit that executes factor analysis with respect to the answers of the plurality of persons to extract a prescribed number of factors and calculates a value based on a distribution of values indicated by the answers to some questions having relatively higher factor loads for each of the extracted factors.

### TECHNICAL FIELD

The present invention relates to an assessment support device, an assessment support method, and a program.

### BACKGROUND ART

From the social background such as the aggravation of global environmental problems and the adoption of sustainable development goals (SDGs), companies are required to carry out sustainable management in consideration of the economy, environment, and society. As an indicator of sustainability, many companies have calculated and appealed for “environmental efficiency”, which indicates the balance between the environment of products and services and economic and social contribution. Environmental efficiency is represented by Equation (1).

(Value/(Environmental load)=Environmental efficiency (1)

However, a standardized concept or index is defined for an environmental load and a value, and each company interprets and defines, and calculates the environmental load and the value independently according to the characteristics of products and services (for example, see NPL 1 and 2).

### CITATION LIST

### Patent Literature

[PTL 1] Japanese Patent No. 6265214

### Non Patent Literature

[NPL 1] DENSO Web Site, [online], Internet <URL:https://www.denso.com/jp/ja/csr/environment-report/product/>

[NPL 2] TOSHIBA Web Site, [online], Internet <URL:https://www.toshiba.co.jp/env/jp/products/ecp/factor2_j.htm>

[NPL 3] ITU-T Recommendation. L. 1410, “Methodology for environmental life cycle assessments of information and communication technology goods, networks and services”, 2014

[NPL 4] Kyohei Kawara, et al., “Hyouka Guriddohou wo Mochiita Sennzaiteki Yokkyuu no Cyuusyutsu to Syouhinn Suisyhou eno Ouyou (Extraction of potential desire using the grid method and its application to product recommendation)”, Annual Report of Satellite Venture Business Laboratory, vol. 8, pp. 97-98, 2009

### SUMMARY OF THE INVENTION

### Technical Problem

For companies including information and communication companies to calculate the environmental efficiency of ICT services, it is necessary to assess the environmental load and the value of ICT services. In this case, an assessment method of an environmental load and an environmental load reduction contribution of an ICT service corresponding to the denominator on the left side of Equation (1) is internationally standardized in ITU-T L.1410 (NPL 3). On the other hand, an assessment method of the value of an ICT service corresponding to the numerator on the left side of Equation (1) is not established, and specific factors of the value are not clear.

A value assessment technique is disclosed in PTL 1. PTL 1 assesses cities as an assessment target and sets and quantifies indices of items such as the atmosphere, the fiscal foundation of governments, and residence from the aspects of the environment, economy, and society. However, since the subject of PTL 1 is the assessment of cities and does not include the emotional aspects of individuals and the elements of the value unique to ICT services that the services are available anytime, anywhere, PTL 1 is not suitable for application to assessment of ICT services.

NPL 4 structures the value of a product by an experiment conducted for general consumers using an assessment grid method. However, since this experiment involves repeatedly exchanging questions and answers between a practitioner and a subject many times to create a structural diagram of the value felt by the consumer, the experiment is time-consuming, which is a heavy burden for both the practitioner and the subject. The assessment grid method is a method of drawing out a cognitive structure of a human by an interview with users and expressing the same as a hierarchical structure diagram and is often used in researches for clinical psychology and marketing field.

The present invention has been made in view of the above-described problems, and an object thereof is to efficiently acquire the elements of the value of an ICT service.

### Means for Solving the Problem

In order to solve the problems, an assessment support device according to the present invention includes: a question generation unit that generates a plurality of questions including a plurality of stages of values with respect to advantages felt about an assessment target service as choices on the basis of information related to states of a user when the user uses the service and when the user does not use the service; an answer acquisition unit that acquires answers of a plurality of persons with respect to the plurality of questions generated by the question generation unit; and a statistics calculation unit that executes factor analysis with respect to the answers of the plurality of persons to extract a prescribed number of factors and calculates a value based on a distribution of values indicated by the answers to some questions having relatively higher factor loads for each of the extracted factors.

### Effects of the Invention

It is possible to efficiently acquire the elements of the value of an ICT service.

### BRIEF DESCRIPTION OF DRAWINGS

FIG. 1 is a diagram illustrating a hardware configuration example of an assessment support device 10 according to an embodiment of the present invention.

FIG. 2 is a diagram illustrating a functional configuration example of the assessment support device 10 according to the embodiment of the present invention.

FIG. 3 is a flowchart for describing an example of the processing procedures executed by the assessment support device 10.

FIG. 4 is a diagram illustrating a configuration example of a conventional method DB 17.

FIG. 5 is a diagram illustrating a configuration example of an ICT service function DB 18.

FIG. 6 is a diagram illustrating an example of the questions of a questionnaire.

FIG. 7 is a diagram illustrating an example of the results of factor analysis for an answer group of a questionnaire.

FIG. 8 is a diagram illustrating a first output example of calculation results.

FIG. 9 is a diagram illustrating a second output example of calculation results.

### DESCRIPTION OF EMBODIMENTS

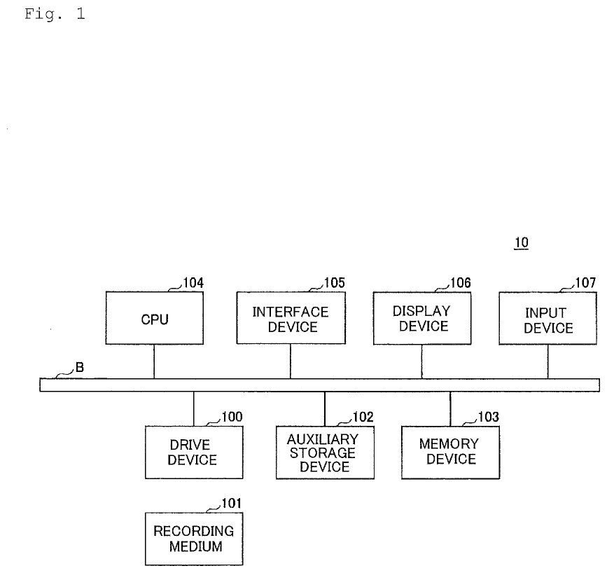

Hereinafter, an embodiment of the present invention will be described with reference to the drawings. FIG. 1 is a diagram illustrating a hardware configuration example of an assessment support device 10 according to an embodiment of the present invention. The assessment support device 10 of FIG. 1 includes a drive device 100, an auxiliary storage device 102, a memory device 103, a CPU 104, an interface device 105, a display device 106, an input device 107, and the like which are connected to each other by a bus B.

A program that realizes processing in the assessment support device 10 is provided by a recording medium 101 such as a CD-ROM. When the recording medium 101 having a program stored therein is set in the drive device 100, the program is installed in the auxiliary storage device 102 from the recording medium 101 via the drive device 100. The program may not necessarily be installed from the recording medium 101 and may be downloaded from another computer via a network. The auxiliary storage device 102 stores the installed program and stores necessary files, data, and the like.

When a program activation instruction is issued, the memory device 103 reads the program from the auxiliary storage device 102 and stores the same therein. The CPU 104 realizes the functions of the assessment support device 10 according to the program stored in the memory device 103. The interface device 105 is used as an interface for connecting to a network. The display device 106 displays a graphical user interface (GUI) or the like according to a program. The input device 107 includes a keyboard, a mouse, and the like and is used for inputting various operation instructions.

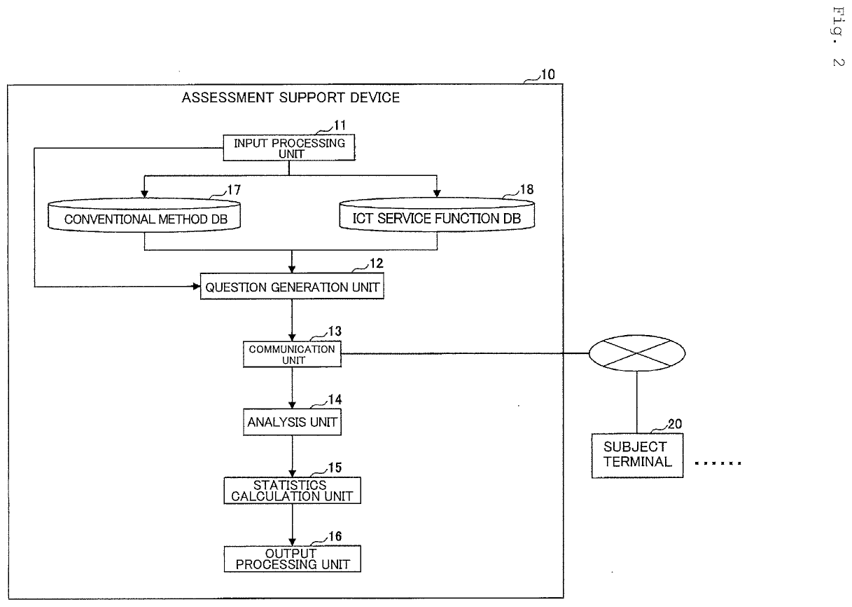

FIG. 2 is a diagram illustrating a functional configuration example of the assessment support device 10 according to the embodiment of the present invention. In FIG. 2, the assessment support device 10 includes an input processing unit 11, a question generation unit 12, a communication unit 13, an analysis unit 14, a statistics calculation unit 15, and an output processing unit 16. These respective units are realized when one or more programs installed in the assessment support device 10 causes the CPU 104 to execute processing. The assessment support device 10 uses databases such as a conventional method DB 17 and an ICT service function DB 18. These respective databases (storage units) can be realized using storage devices and the like connectable to the auxiliary storage device 102 or the assessment support device 10 via a network, for example.

The assessment support device 10 calculates and outputs the elements of the value of an ICT service using the respective units and the respective databases illustrated in FIG. 2. The elements of the value of an ICT service are not the value (the value used in Equation (1)) itself of an ICT service but are indices usable as elements for calculating the value.

The assessment support device 10 may include a plurality of computers. In this case, the respective units or the respective databases illustrated in FIG. 2 may be disposed and distributed in a plurality of computers.

In FIG. 2, the assessment support device 10 is connected to a plurality of subject terminals 20 via a network such as the Internet. The subject terminal 20 is a terminal used by a subject of a questionnaire for assessing the elements of the value of an ICT service. For example, a personal computer (PC), a smartphone, a tablet terminal, or the like may be used as the subject terminal 20.

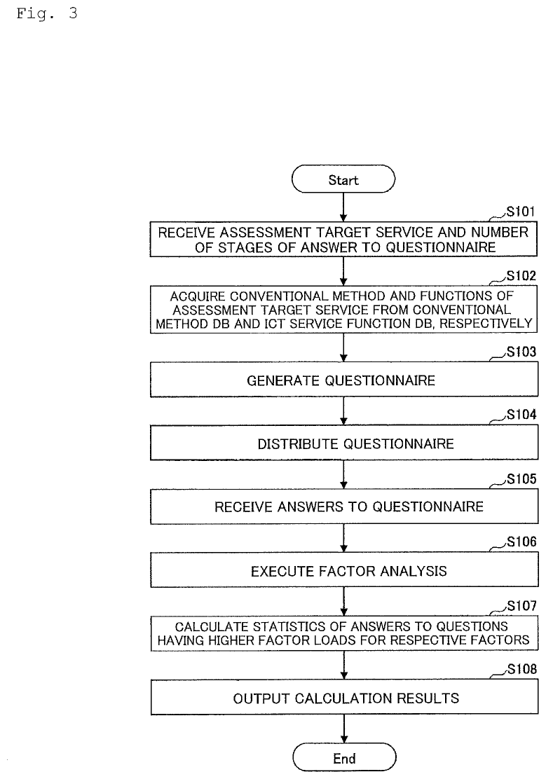

Hereinafter, the processing procedures executed by the assessment support device 10 will be described. FIG. 3 is a flowchart for describing an example of the processing procedures executed by the assessment support device 10.

In step S101, the input processing unit 11 receives the input of identification information of an assessment target service and the number of stages (the number of choices) of the answer to a questionnaire from an assessment practitioner, for example. In this case, a questionnaire refers to a set of questions asking about the degree of attractiveness and merits (advantages) felt with respect to the fact that a conventional method needs not be performed and the functions of an assessment target service. A conventional method refers to the state of users before an ICT service is used for a certain purpose. For example, online shopping is a service used for buying things, and a conventional method thereof is “go to an actual store”. The function of an assessment target service refers to the state of users when the assessment target service is used. The number of stages refers to the number of a plurality of stages from “Do not feel any merit” to “Feel merits very much”. In this example, a service ID of “online shopping” is input as an assessment target service, and “7” is input as the number of stages of answer.

Subsequently, the question generation unit 12 acquires a conventional method related to the assessment target service from the conventional method DB 17 and acquires the function of the assessment target service from the ICT service function DB 18 of an ICT service (S102).

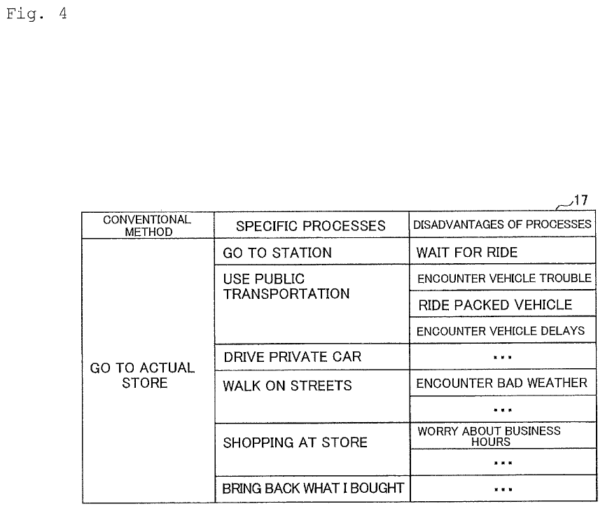

FIG. 4 is a diagram illustrating a configuration example of the conventional method DB 17. The disadvantages of each of specific processes required in the conventional method (the state before using the assessment target service) are stored in the conventional method DB 17.

FIG. 4 illustrates an example in which “go to an actual store” is registered as a conventional method for online shopping which is the assessment target service. Therefore, the disadvantages of each of specific processes for “going to an actual store” are illustrated. However, some processes (for example, “go to a station”, “use public transportation”, and “drive a private car”) are in a selective relationship. The information stored in the conventional method DB 17 is registered in advance by an assessment practitioner, for example.

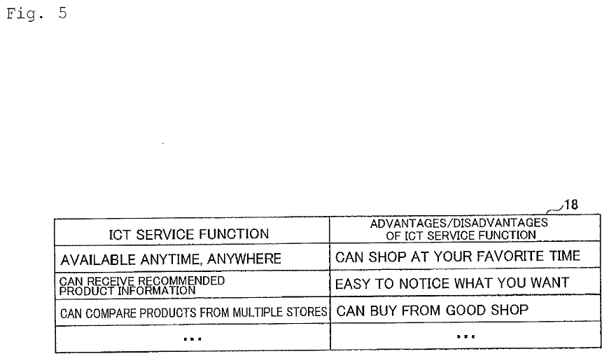

FIG. 5 is a diagram illustrating a configuration example of the ICT service function DB 18. The advantages or disadvantages of using each of functions (hereinafter referred to as “ICT service functions”) of an ICT service usable in a state when users use the ICT service for a certain purpose are stored in the ICT service function DB 18. The advantages or disadvantages of using each of the functions usable in an online shopping which is an assessment target service. The information stored in the ICT service function DB 18 is registered in advance by an assessment practitioner, for example.

Subsequently, the question generation unit 12 generates questions of a questionnaire asking about the degree of attractiveness and merits (advantages) felt with respect to the fact that a conventional method needs not be performed and the functions of an assessment target service on the basis of the information acquired from the conventional method DB 17 and the information acquired from the ICT service function DB (S103).

The question based on the information stored in the conventional method DB 17 is generated for each process of the conventional method on the basis of the rule that “since <conventional method> is not performed, users do not need to experience <disadvantages of process>”. Here, the content in < > is substituted with a value corresponding to the character string in < >.

The question based on the information stored in the ICT service function DB 18 is generated for each ICT service function on the basis of a rule that “users experience <advantages/disadvantages of function> due to <function>”.

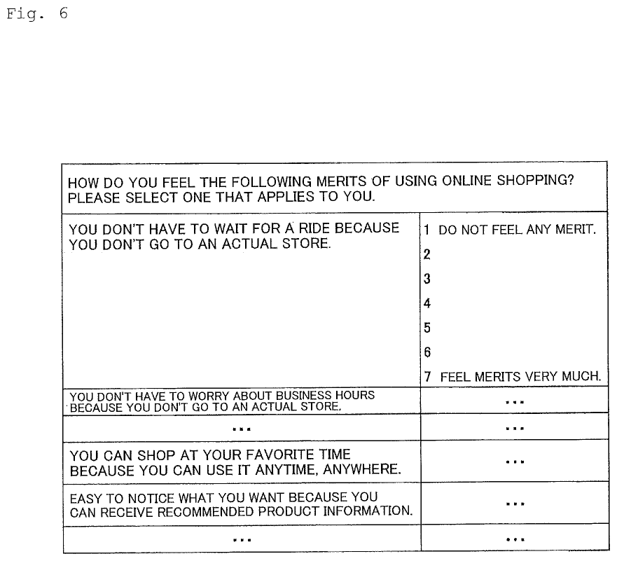

The questions generated on the basis of FIGS. 4 and 5 are illustrated in FIG. 6, for example. FIG. 6 is a diagram illustrating an example of the questions of a questionnaire. The answers to each question include choices of each stage obtained by dividing the range from “Do not feel any merit” to “Feel merits very much” by the number of stages input in step S101.

Subsequently, the communication unit 13 distributes electronic data (hereinafter referred to as “questionnaire data”) of a questionnaire including the questions generated by the question generation unit 12 to the respective subject terminals 20 registered in advance (S104). Subsequently, the communication unit 13 receives (acquires) the questionnaire data in which answers are input with respect to the questions by the respective subject terminals 20 (S105). The questionnaire data is received until the questionnaire data (the answers from a plurality of subjects) is received from all destination subject terminals 20 of the questionnaire data or a prescribed number or more of subject terminals 20.

Subsequently, in step S106, the analysis unit 14 executes factor analysis with respect to an answer group included in a questionnaire data group received by the communication unit 13 to extract a prescribed number of factors set in advance. The prescribed number (the number of factors) may be determined on the basis of a known technique. Multivariate analysis other than factor analysis such as principal component analysis may be performed.

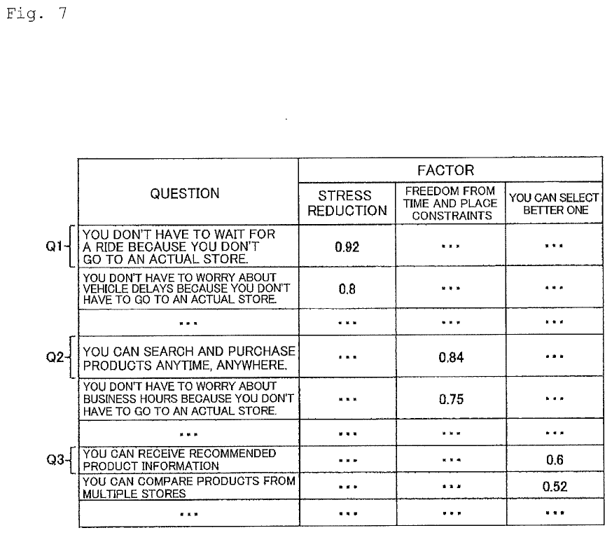

FIG. 7 is a diagram illustrating an example of the results of factor analysis with respect to an answer group of a questionnaire. FIG. 7 illustrates a factor load to each factor of each question of the questionnaire in which the number of factors is 3.

Although names (“stress reduction”, “freedom from time and place constraints”, and “can select better one”) are assigned to each factor in FIG. 7, the names of each factor are not automatically assigned by factor analysis. For example, the analysis unit 14 may transmit the same data as in FIG. 7 in which no name is assigned to a factor to the terminal of an assessment practitioner via the communication unit 13, and the assessment practitioner may assign names to respective factors on the basis of the commonality of questions having a relatively high factor load on the factor by referring to the data. In this case, the terminal of the assessment practitioner obtains analysis results in which a name is assigned to each factor when the terminal transmits the data in which names are assigned to the assessment support device 10 and the analysis unit 14 receives the data via the communication unit 13. The question having a relatively high factor load is questions of which the rank of the factor load is the N-th or lower rank in descending order and questions of which the factor load is equal to or larger than a threshold, for example.

The names of factors illustrated in FIG. 7 are assigned on the basis of the commonality. In the following description, data (the data illustrated in FIG. 7) in which names are assigned to factors is a processing target. However, the name of each factor may not be assigned at this time point. In this case, labels such as “factor 1”, “factor 2”, or “factor 3” may be automatically assigned to each factor.

Subsequently, the statistics calculation unit 15 specifies a question having the largest factor load for each of the respective extracted factors and calculates the statistics of the values indicated by the answers (answers of the seven stages of 1 to 7) from the subject terminals 20 for the question (S107). For example, according to FIG. 7, a question having the largest factor load for “stress reduction” is a question Q1. Moreover, a question having the largest factor load for “freedom from time and place constraints” is a question Q2. Furthermore, a question having the largest factor load for “can select better one” is a question Q3. Therefore, the statistics of the values indicated by the answers are calculated for each of the questions Q1, Q2, and Q3. The average value of the values indicated by the answers may be calculated as the statistics, for example. In this example, the averages of the factors are calculated as 5.3, 6.0, and 5.0.

A distribution of the values indicated by the answers may be calculated as the statistics. Here, a distribution may be the percentage of the number of answerers in each stage (the percentage to the number of all answerers) and may be a distribution of the number of answerers itself.

In step S107, a calculation target of the statistics may not be limited to the question having the largest factor load. For example, the statistics calculation unit 15 may calculate, for each factor, an average or a distribution of an answer group with respect to some questions of which the ranks of the factor loads are N-th or lower in descending order or the statistics of an answer group with respect to some questions of which the factor loads are equal to or larger than a threshold. That is, the statistics of the values of answers with respect to some questions having relatively higher factor loads may be calculated.

Subsequently, the output processing unit 16 outputs the calculation results of the statistics calculation unit 15 (S108). The output format is not particularly limited. For example, the calculation results may be displayed on the display device 106, may be stored in the auxiliary storage device 102, may be output to a printer, and may be transmitted to another device via a network.

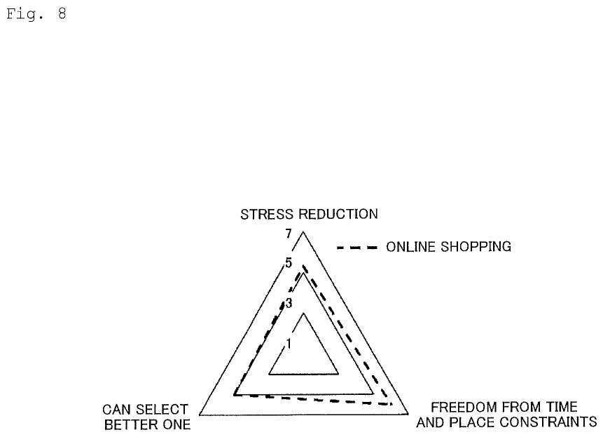

FIG. 8 is a diagram illustrating a first output example of the calculation results. In FIG. 8, the averages calculated for each factor are illustrated as an example of the elements of value. A weighted sum of the averages of each factor may be used as the “value” for calculating the environmental efficiency.

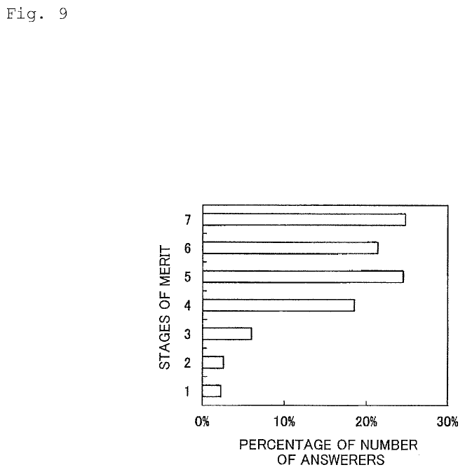

FIG. 9 is a diagram illustrating a second output example of the calculation results. In FIG. 9, a distribution of answers for “stress reduction” which is one factor is illustrated as an example of the elements of value. Although a distribution of answers for only one factor is illustrated in FIG. 9 for the convenience's sake, the distributions of answers for respective factors may be output.

An assessment practitioner can grasp each factor, the averages of each factor, or a distribution of answers as the elements of the value of the assessment target service by referring to the visualized output results.

As described above, according to the present embodiment, a questionnaire is generated on the basis of the disadvantages of specific processes of a conventional method and the advantages or disadvantages of the functions of an ICT service. Moreover, it is possible to acquire (derive) the elements of the value of an ICT service from one answer to the questionnaire. Since users need to answer a question only once, it is possible to shorten the time required for assessing the elements of the value of an ICT service and alleviate the burden on an assessment practitioner and a subject. Therefore, it is possible to efficiently acquire the elements of the value of the ICT service by taking the emotion of individuals and the characteristics of the ICT service that the services are available anytime, anywhere into consideration. As a result, it is possible to assist companies and research institutes in assessing the environmental efficiency of an ICT service and the changes therein.

Since the acquired elements of the value are output, it is possible to visualize the elements of the value.

The communication unit 13 is an example of an answer acquisition unit.

While an embodiment of the present invention has been described, the present invention is not limited to such a specific embodiment, and various modification and changes can be made within the scope of the spirit of the present invention described in the claims.

### REFERENCE SIGNS LIST

10 Assessment support device
11 Input processing unit
12 Question generation unit
13 Communication unit
14 Analysis unit
15 Statistics calculation unit
16 Output processing unit
17 Conventional method DB
18 ICT service function DB
20 Subject terminal
100 Drive device
101 Recording medium
102 Auxiliary storage device
103 Memory device
104 CPU
105 Interface device
106 Display device
107 Input device
B Bus

1. An assessment support device comprising:
a memory; and
a processor that is coupled to the memory and that is configured to
generate a plurality of questions including a plurality of stages of values with respect to advantages felt about an assessment target service as choices on the basis of information related to states of a user when the user uses the service and when the user does not use the service;
acquire answers of a plurality of persons with respect to the plurality of questions; and
execute factor analysis with respect to the answers of the plurality of persons to extract a prescribed number of factors and calculate a value based on a distribution of values indicated by the answers to some questions having relatively higher factor loads for each of the extracted factors.

2. The assessment support device according to claim 1, wherein the processor calculates an average of the values indicated by the answers to some questions having relatively higher factor loads for each of the extracted factors.

3. The assessment support device according to claim 1, wherein the processor calculates a percentage of the values indicated by the answers to some questions having relatively higher factor loads for each of the extracted factors.

4. An assessment support method for causing a computer to execute:
generating a plurality of questions including a plurality of stages of values with respect to advantages felt about an assessment target service as choices on the basis of information related to states of a user when the user uses the service and when the user does not use the service;
acquiring answers of a plurality of persons with respect to the plurality of questions; and
executing factor analysis with respect to the answers of the plurality of persons to extract a prescribed number of factors and calculating a value based on a distribution of values indicated by the answers to some questions having relatively higher factor loads for each of the extracted factors.

5. The assessment support method according to claim 4, wherein the calculating involves calculating an average of the values indicated by the answers to some questions having relatively higher factor loads for each of the extracted factors.

6. The assessment support method according to claim 4, wherein the calculating involves calculating a percentage of the values indicated by the answers to some questions having relatively higher factor loads for each of the extracted factors.

7. A non-transitory computer-readable recording medium having stored therein a program for causing a computer to execute the assessment support method according to claim 4.
